(19) United States
(12) Patent Application Publication
(10) Pub. No.: US 2003/0018770 A1
(43) Pub. Date: Jan. 23, 2003

(54) System for remotely managing network through serial ports

(76) Inventor: Young-Ju Bae, Seoul (KR)

Correspondence Address: Robert Berliner, Fulbright & Jaworski, 865 South Figueroa, 29th Floor, Los Angeles, CA, 90017-2571, US

(21) Appl. No.: 10/048,422

(22) PCT Filed: Feb. 22, 2001
(86) PCT No.: PCT/KR01/00264

(30) Foreign Application Priority Data
May 29, 2000 (KR) 2000-28994

(51) Int. Cl. G06F 15/173

(52) U.S. Cl. 709/223

(57) ABSTRACT

Disclosed is a system for remotely managing a network through serial ports. The system comprises managed systems (110, 120) including a keyboard port and a monitor port, and a serial port having at least a transmission terminal and a reception terminal, the keyboard port and the monitor port having a higher priority than the serial port; a LAN (150) for enabling access to the managed systems (110, 120); a host box (100) including a switch realized through a single movable contact point connected to the LAN (150) and a plurality of fixed contact points connected to the managed systems; a keybox (118) interposed between the managed systems (110, 120) and the host box (100), the keybox (118) selectively outputting signals transmitted from the host box (100) to the output terminal of the keyboard port of the managed systems and to the serial port of the managed systems in accordance with the connection of a keyboard (114) and a monitor (116) respectively to the keyboard port and the monitor port; and a remote management server (160) connected to the LAN (150) via the Internet (40), the remote management server (160) performing the management of the managed systems through the host box (100).

### BACKGROUND OF THE INVENTION

(a) Field of the Invention

The present invention relates to a network management system, and more particularly, to a system for remotely managing a network through serial ports in which a network can be managed from a remote management server even in a state where a keyboard and monitor are connected to a managed system.

(b) Description of the Related Art

A network management system (NMS) performs a variety of tasks so that a network operates smoothly. They include ensuring that the network is protected from unauthorized users, eliminating bottlenecks in the network, and making sure the network is available to users and responding to hardware and software malfunctions.

FIG. 1 shows a schematic view illustrating a complete network configuration of a prior art system for remotely managing a network using serial ports. The drawing is reproduced from Aurora Technology's website in which their Control Tower™ Console Management System is described.

As shown in the drawings, the remote management system includes two main elements, that is, a management server 30 and a plurality of managed systems 10 connected to the management server 30. The management server 30 has as hardware a multiport console interface 36. As software, the management server 30 has (a) a host program module 32 that controls and monitors the managed systems and (b) a viewer program module 34 that enables access to the host program module 32 from a remote control server 50 via a TCP/IF (transfer control protocol/Internet protocol), that is, the Internet 40.

The multiport console interface 36 is connected to a serial port of each managed system 10 via, for example, a RS-232C interface. The management server 30 further includes a keyboard 37 and a monitor 38 also for controlling and monitoring the managed systems 10. The managed systems 10 can be various servers of Internet sites, and the functions that can be performed include the rebooting of the managed systems 10, log file monitoring, key input, and the running of various diagnoses.

In most computers using a Sun Solaris or UNIX system as an operating system, a higher priority is given to a keyboard port or monitor port than to a serial port connecting a modem or line printer. For the Control Tower™ Console Management System, an operator program is managed when a keyboard and monitor are not connected to each managed system.

However, there are various instances when an operator needs to directly operate the managed systems, and with the prior art systems, this is not possible. That is, if a keyboard and monitor are connected to the managed systems to allow such direct operation, network management at a management server or a remote control server with respect to the managed systems is not possible since the monitor and keyboard have a higher priority.

### SUMMARY OF THE INVENTION

The present invention has been made in an effort to solve the above problems.

It is an object of the present invention to provide a system for remotely managing a network through serial ports in which a network can be managed from a remote management server even in a state where a keyboard and monitor are connected to a managed system.

To achieve the above object, the present invention provides a system for remotely managing a network through serial ports comprising managed systems including a keyboard port and a monitor port, and a serial port having at least a transmission terminal and a reception terminal, the keyboard port and the monitor port having a higher priority than the serial port; a LAN for enabling access to the managed systems; a host box including a switch realized through a single movable contact point connected to the LAN and a plurality of fixed contact points connected to the managed systems; a keybox interposed between the managed systems and the host box, the keybox selectively outputting signals transmitted from the host box to the output terminal of the keyboard port of the managed systems and to the serial port of the managed systems in accordance with the connection of a keyboard and a monitor respectively to the keyboard port and the monitor port; and a remote management server connected to the LAN via the Internet, the remote management server performing the management of the managed systems through the host box.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic view illustrating a complete network configuration of a prior art system for remotely managing a network using serial ports;

FIG. 2 is a schematic view illustrating a complete network configuration of a system for remotely managing a network using serial ports according to a preferred embodiment of the present invention;

FIG. 3 is an internal schematic view of host box of FIG. 2; and

FIG. 4 is an internal schematic view of a keybox of FIG. 2.

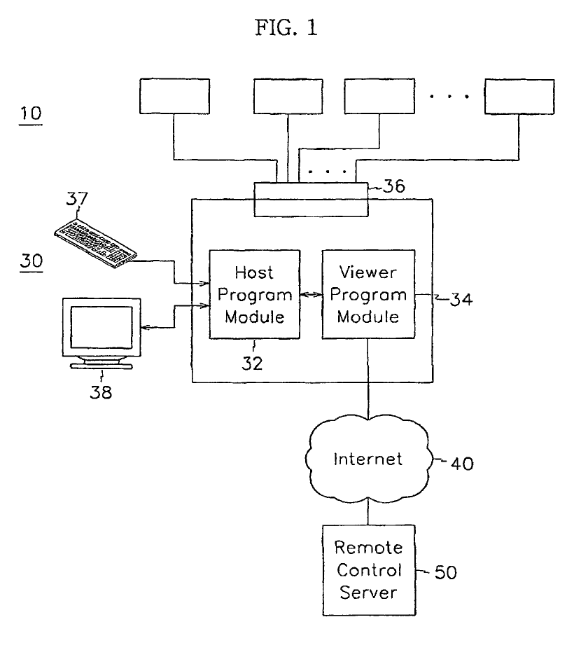

### DETAILED DESCRIPTION OF THE PREFERRED EMBODIMENTS

Preferred embodiments of the present invention will now be described in detail with reference to the accompanying drawings.

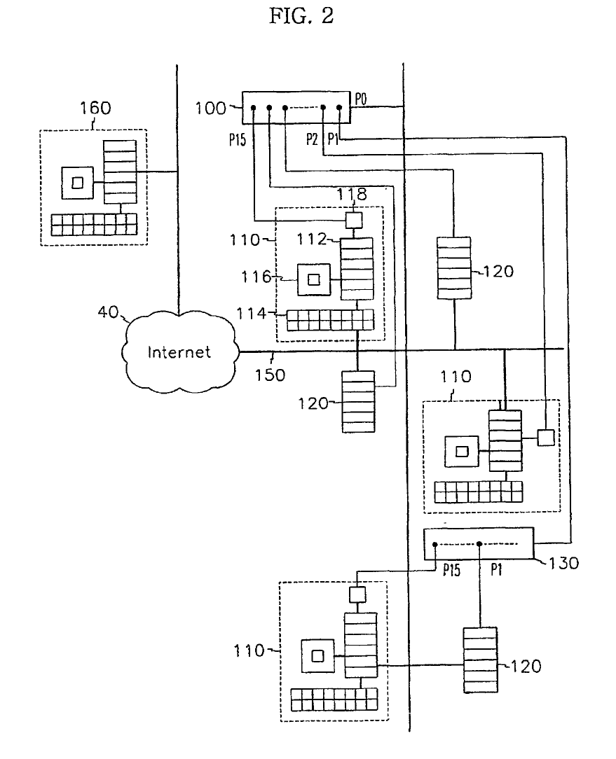

FIG. 2 shows a schematic view illustrating a complete network configuration of a system for remotely managing a network using serial ports according to a preferred embodiment of the present invention.

As shown in the drawing, the network configuration of the system of the present invention includes a serial controller (hereinafter referred to as a “host box”) 100 acting as a host and having a plurality of connection ports P0-P15; managed systems 110 and 120 connected to the ports P1-P15 of the host box 100; a LAN 150 connecting each managed system 100 and 120 for enabling remote access to the managed systems 100 and 120; and a remote management server 160 remotely connected to the managed systems 110 and 120 via the LAN 150 and the Internet 40.

The LAN 150 is connected to one of the plurality of ports P0-P15 of the host box 100. In the present invention, though not limited to this configuration, the LAN 150 is connected to the port P0. Further, it is possible for the managed systems 110 and 120 to both be equipped with a keyboard and monitor or include only a main body with no keyboard and monitor connected thereto. In the present invention, a keyboard 114 and a monitor 116 are connected to the managed systems 110, while the managed systems 120 are comprised of only a main body. A means (hereinafter referred to as a keybox) 118, for either transmitting signals received from the host box 100 to an output terminal or a serial port of the keyboard 114 connected to the main body 112, is connected to the main body 112 of the managed systems 110.

In the above configuration, since an IP address is assigned to the host box 100, control is able to be performed in the remote management server 160 as long as the LAN 160 is not malfunctioning.

Reference numeral 130 in FIG. 2 refers to an extension host box. The extension host box 130 is additionally provided in the case where, for example, there are more than 15 managed systems 110 and 120. With the addition of the extension host box 130, a maximum of 127 managed systems 110 and 120 can be connected to the system. Also, it is possible for the remote management server 160 of FIG. 2 to be a network management agency.

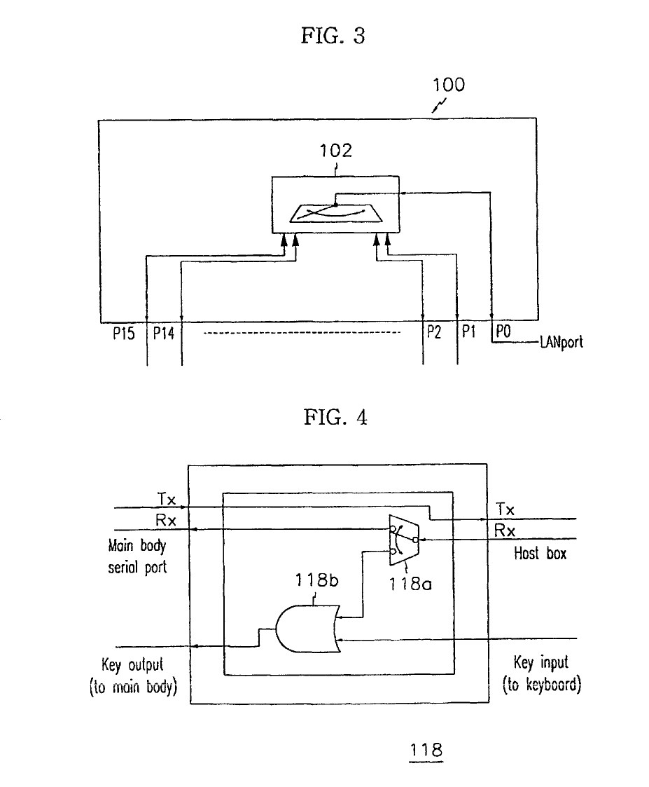

FIG. 3 is an internal schematic view of the host box 100. The elements of the host box 100 appearing in FIG. 3 are also applicable to the extension host box 130. As shown in the drawing, the host box 100 includes a plurality of ports P0-P16 and a single switch 102. The port P0, which is connected to the LAN 150, is connected to a movable contact point of the switch 102, and the remaining ports P1-P15 are connected to fixed contact points of the switch 102. The switch 102 can be either a hardware switch or a software switch.

FIG. 4 shows an internal schematic view of the keybox 118. As shown in the drawing, the keybox 118 includes a switch 118a and an OR gate 118b. The serial ports P0-P15 connected to the managed systems 110 and 120 include a transmission terminal Tx and reception terminal Rx on the basis of the managed systems 110 and 120. In the case of the transmission terminal Tx, connection to the transmission terminal Tx of the host box 100 is realized by passing through the keybox 118.

The switch 118a includes a single movable contact point connected to the reception terminal Rx of the host box 100 and two fixed contact points connected to the reception terminals Rx of the managed systems 110 and one input terminal of the OR gate 118b. A key input terminal of the keyboard 114 is connected to the other input terminal of the OR gate 118b, and an output terminal of the OR gate 118b is connected to the key output terminal of the keyboard 114.

In the above configuration, the OR gate 118b receives signals of the keyboard 114 and reception terminal Rx signals of the serial ports, and transmits the signals to the keyboard ports of the managed systems 110. In the case where the keyboard 114 and monitor 116 are connected to the managed systems 110, commands of the remote management server 160 pass through, in sequence, a corresponding port of the host box 100, and the switch 118a and the OR gate 118b of the keybox 118. The commands are then automatically sent to the key output terminal of the keyboard 114 of the managed system 110 such that the conventional problem of priority is solved. Of course, since signals of the key input terminal of the keyboard 114 are also sent to the key output terminal of the keyboard 114 of the managed system 110, required key input operations are able to be performed through the managed system 110.

In the case of the managed system 120 to which a keyboard and monitor are not connected, signals from the remote management server 160 are transmitted through a serial port of the managed system 120 by a keybox member as in the prior art.

In the above structure, the switch 118a is realized through a TTL (transistor transistor logic) logic gate such that setting can be performed by a systems administrator of a network management agency when the network management system is set up.

In the system for remotely managing a network through serial ports of the present invention as described above, since network management of managed systems is possible even in a state where a keyboard and monitor are connected to the managed systems, key input required by the managed systems is able to be performed. Accordingly, an increased scope of application is realized with the present invention when compared to prior art systems.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

For example, the present invention can be utilized with various operating systems such as the Sun Solaris operating system, Hewlett-Packard's operating system, IBM's OS/2 operating system, and Microsoft's NT server.

What is claimed is:

1. A system for remotely managing a network through serial ports comprising:
managed systems including a keyboard port and a monitor port, and a serial port having at least a transmission terminal and a reception terminal, the keyboard port and the monitor port having a higher priority than the serial port;
a LAN for enabling access to the managed systems;
a host box including a switch realized through a single movable contact point connected to the LAN and a plurality of fixed contact points connected to the managed systems;
a keybox interposed between the managed systems and the host box, the keybox selectively outputting signals transmitted from the host box to the output terminal of the keyboard port of the managed systems and to the serial port of the managed systems in accordance with the connection of a keyboard and a monitor respectively to the keyboard port and the monitor port; and
a remote management server connected to the LAN via the Internet, the remote management server performing the management of the managed systems through the host box.
